(19) United States
(12) Patent Application Publication
(10) Pub. No.: US 2019/0083211 A1
(43) Pub. Date: Mar. 21, 2019

(54) DENTURE MOLDING FLASK HAVING CHECK VALVE INSTALLED THEREIN AND METHOD FOR MANUFACTURING DENTURE PROSTHESIS USING DENTURE MOLDING FLASK MADE OF HETEROGENEOUS MATERIALS

(71) Applicant: DK MUNGYO CORPORATION, GIMHAE-SI, GYEONGNAM (KR)

(72) Inventor: Doo Suek NAM, Busan (KR)

(21) Appl. No.: 15/751,527

(22) PCT Filed: Feb. 17, 2017
(86) PCT No.: PCT/KR2017/001788

§ 371 Date: Dec. 6, 2018

(30) Foreign Application Priority Data
Feb. 19, 2016 (KR) 10-2016-0019980
Feb. 19, 2016 (KR) 10-2016-0019988

(51) Int. Cl. A61C 13/16; A61C 13/01; A61C 13/08

(52) U.S. Cl. CPC A61C 13/16; A61C 13/081; A61C 13/04

(57) ABSTRACT

Disclosed is a method of manufacturing a denture prosthesis by using a denture molding flask made of heterogeneous materials, the denture molding flask being composed of a left body (110) and a right body (120) coupled to each other to form an assembled structure, in which: a resin injection hole (104) is formed at a top portion of the assembled structure; an investment material injection hole (103) is provided to be spaced from the resin injection hole (104); a wax outlet (106) is formed at a bottom portion of the assembled structure such that molten wax is discharged out of the assembled structure when a wax denture base and an investment material in the assembled structure are heated and melted; and a void that is formed due to the wax denture base being melted is refilled with resin, wherein the left and right bodies (110, 120) are made of different materials.

This application claims priority to and the benefit of Korean Patent Application No. 10-2016-0019980, filed on Feb. 19, 2016, Korean Patent Application No. 10-2016-0019988, filed on Feb. 19, 2016 and PCT Application No PCT/KR2017/001788, filed on Feb. 17, 2017 the entire contents of which are incorporated herein by reference.

### BACKGROUND

### 1. Field

The present inventive concept relates generally to a denture molding flask with a check valve installed therein and a method of manufacturing a dental prosthesis by using a denture molding flask made of heterogeneous materials. More particularly, the present inventive concept relates to a denture molding flask with a check valve installed therein and a method of manufacturing a dental prosthesis by using a dental molding flask made of heterogeneous materials, in which: the check valve-equipped flask is used such that a plaster mold is inserted into the check valve-equipped flask and a partial denture or a complete denture made of a predetermined dental plate material is formed through molding; and the flask is made of heterogeneous materials such that a right part thereof is made of a metal with a higher thermal conductivity and a left part thereof is made of plastic with a lower thermal conductivity, thereby preventing deformation of resin.

### 2. Description of the Related Art

In general, a flask is used to form a denture (dental prosthesis) conforming to a person's teeth. A denture is manufactured by first forming a model of a person's teeth with the use of a dental impression material and then casting a denture using the model.

A denture refers to a dental prosthesis to replace missing teeth when natural teeth are lost for any reason.

In order to produce such a dental prosthesis, a wax denture is first prepared and then provisionally applied to the patient's oral cavity to check for the functional and aesthetic properties thereof. Afterwards, when the checking reveals no problem, most parts of a denture except an artificial teeth portion are manufactured through resin polymerization by using the wax denture.

In this case, the wax denture is a kind of provisional denture prepared for the purpose of checking for esthetics, occlusion, pronunciation, etc. in the oral cavity of a patient prior to completion of preparation of a final partial or complete denture prosthesis. Generally, artificial teeth are arranged on a base plate and a denture base is made by carving wax. Accordingly, this denture is called a wax trial denture.

In order to manufacture a final denture using a wax trial denture, the wax trial denture is first invested in a flask, the flask is then immersed in hot water so that the wax can be heated and softened, the flask is then divided (into an upper-half flask and a lower-half flask), a resin separating medium is applied to the upper-half flask and the lower-half flask, and the upper-half and lower-half flasks are assembled again.

Next, a sufficiently mixed dough-state resin of an optimal color selected from various colors is injected into the assembled flask to undergo sufficient thermal polymerization, a resin denture formed through the thermal polymerization is taken out of the flask, and the resin denture undergoes trimming and grinding to produce a finished denture.

There is an existing technology, ‘Catalytic Burner and Flask Equipped with Same’ (Korean Patent No. 10-0479199), relating to a catalytic combustion burner made of a porous material, the burner having a cavity portion extending in a substantially axial direction and configured to accommodate a core designed to transfer a combustible liquid to the burner in a lower portion thereof and a ring-shaped peripheral portion provided with catalyst and configured to surround a center region, which is provided with no catalyst and serves as a vaporization region, in an upper portion thereof. An open channel via which an upper portion of the hollow portion communicates with an outside space is provided in the upper portion of the burner.

There is another existing technology, ‘Denture Molding Flask’(Korean Patent NO. 10-0548957). The denture molding flask is a device used to produce a denture in such a manner that a molten material is injected into a cavity portion of the denture molding flask, which is assembled using coupling bolts, through a sprue. The flask has a structure including: an upper plate having an injection pipe, an ejector, an air hole, guide pins, and nuts to be engaged with coupling bolts; a lower plate having an injection pipe, an ejector, an air hole, guide holes, and bushings to be engaged with coupling bolts; a pressing part having pressing pieces coupled to respective ends of a spring, the pressing part being accommodated in a connection pipe in a compressed state via a cap nut; and a conduit part having a first inner member installed in the sprue, a second inner member installed in the connection pipe, a third inner member installed in the pressing part, and a fourth member installed in an upper portion of an inside space defined by the upper plate and the lower plate.

However, the existing products described above have a disadvantage that the flask needs to be divided into halves during wax removal and resin insertion in the process of manufacturing a denture prosthesis. Therefore, there is a problem that the manufacturing time is long and the working environment is dirty.

When the divided halves of the flask are coupled again with a clamp after the resin injection, there is a problem in that a produced dental prosthesis is likely to be deformed, resulting in a numerical error. Therefore, a dental prosthesis needs to be newly manufactured, thereby lowering work efficiency.

### SUMMARY

The described technology has been made in an effort to provide a head mounted display device that can prevent occurrence of a screen door effect, and reduce weight and size of the display device.

A head mounted display device according to an exemplary embodiment includes: a display panel including a plurality of pixels; and a microlens array that includes a plurality of lenses that respectively overlap the plurality of pixels wherein the plurality of pixels and the plurality of lenses have one-to-one correspondence.

The plurality of lenses may have different focal distances.

The plurality of lenses may include a first lens having a shortest distance from a pupil of a user, and the first lens may have the shortest focal distance among the plurality of lenses.

### BRIEF DESCRIPTION OF THE DRAWINGS

FIG. 1 is a perspective view of an existing denture molding flask;

FIG. 2 is an exploded perspective view illustrating an assembling process of the existing denture molding flask;

FIG. 3 is a picture illustrating the internal structure of the existing denture molding flask;

FIG. 4 is a top view picture of the existing denture molding flask;

FIG. 5 is a bottom view picture of the existing denture molding flask;

FIG. 6 is a front view picture of the existing denture molding flask;

FIG. 7 is a perspective view of a denture molding flask equipped with a check valve, according to the present inventive concept;

FIG. 8 is a picture of the denture molding flask equipped with a check valve, according to the present inventive concept;

FIG. 9 is a picture of the denture molding flask made of heterogeneous materials, according to the present inventive concept;

FIG. 10 is a top view picture of the denture molding flask made of heterogeneous materials, according to the present inventive concept; and

FIG. 11 is a picture of a denture prosthesis produced according to the present inventive concept.

### DETAILED DESCRIPTION

The present inventive concept relates to a method of manufacturing a denture prosthesis by using a denture molding flask made of heterogeneous materials, the denture molding flask being a member used to manufacture a denture prosthesis and composed of a left body 110 and a right body 120 coupled to each other, in which: a resin injection hole 104 through which resin is injected is formed at a top portion of an assembled structure of the left body 10 and the right body 120; an investment material injection hole 103 through which plaster serving as an investment material is injected is provided at a position spaced from the resin injection hole 104 by a predetermined distance; a space portion is formed in the assembled structure of the left body 110 and the right body 120; an investment material is injected into the space portion through the investment material injection hole 103 after a wax denture base is inserted into the space portion; a wax outlet 106 through which molten wax is discharged outside is formed at a bottom portion of the assembled structure of the left body 110 and the right body 120 such that the molten wax is discharged outside while the denture base and the investment material in the space portion 101 are heated; a void formed due to the wax denture base being melted is refilled with resin injected through the resin injection hole 104 to produce the denture prosthesis,

wherein the denture molding flask is characterized in that the left body 110 and the right body 120 are made of respectively different materials, thereby minimizing polymerization shrinkage and deformation of a dental prosthesis formed in the left body 110 and the right body 120.

In addition, the left body is made of a metal material having a higher thermal conductivity and the right body is made of a plastic material having a lower thermal conductivity.

In addition, a gum portion of the denture prosthesis is molded in the left body made of a metal material with a higher thermal conductivity and a teeth portion of the denture prosthesis is molded in the right body made of a plastic material with lower thermal conductivity.

The present inventive concept relates to a denture molding flask equipped with a check valve, the denture molding flask being used to produce a denture prosthesis and being composed of a left body 110 and a right body 120 coupled to each other, in which: a resin injection hole 104 through which resin is injected is formed at a top portion of an assembled structure of the left body 10 and the right body 120; an investment material injection hole 103 through which plaster serving as an investment material is injected is provided at a position spaced from the resin injection hole 104 by a predetermined distance; a space portion is formed in the assembled structure of the left body 110 and the right body 120; an investment material is injected into the space portion through the investment material injection hole 103 after a wax denture base is inserted into the space portion; a wax outlet 106 through which molten wax is discharged outside is formed at a bottom portion of the assembled structure of the left body 110 and the right body 120 such that the molten wax is discharged outside while the denture base and the investment material in the space portion 101 are heated; a void formed due to the wax denture base being melted is refilled with resin injected through the resin injection hole 104,

wherein the resin injection hole 104 is connected to a check valve 10, thereby preventing deformation of a product, which is attributable to shrinkage of resin and internal pressure drop.

In addition, the check valve 200 includes a body 210 having an upper hole 211 and a lower hole 212 respectively formed at an upper portion and a lower portion thereof, a cover 220 installed at a top portion of the body 210 and provided with a central hole, and a ball 230 installed in the body 210 and adapted to move in a vertical direction.

In addition, support pieces 214 are provided in a matrix form in the lower hole 212 of the body such that the support pieces 214 prevents the ball 230 from escaping the body through the lower hole 212.

In addition, the central hole of the cover 220 has a diameter smaller than that of the ball 230, thereby preventing the ball 230 from escaping the body through the central hole of the cover 220.

Hereinbelow, the present inventive concept is described below in greater detail.

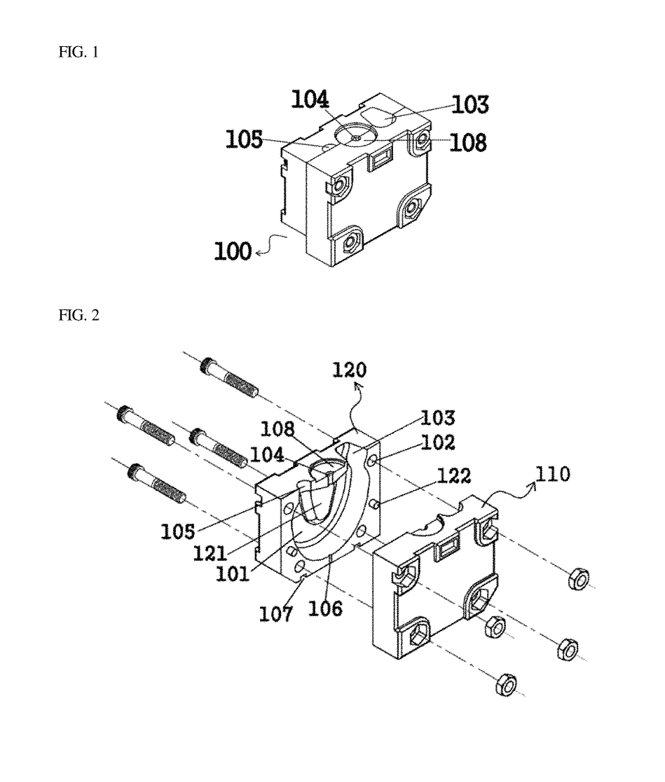

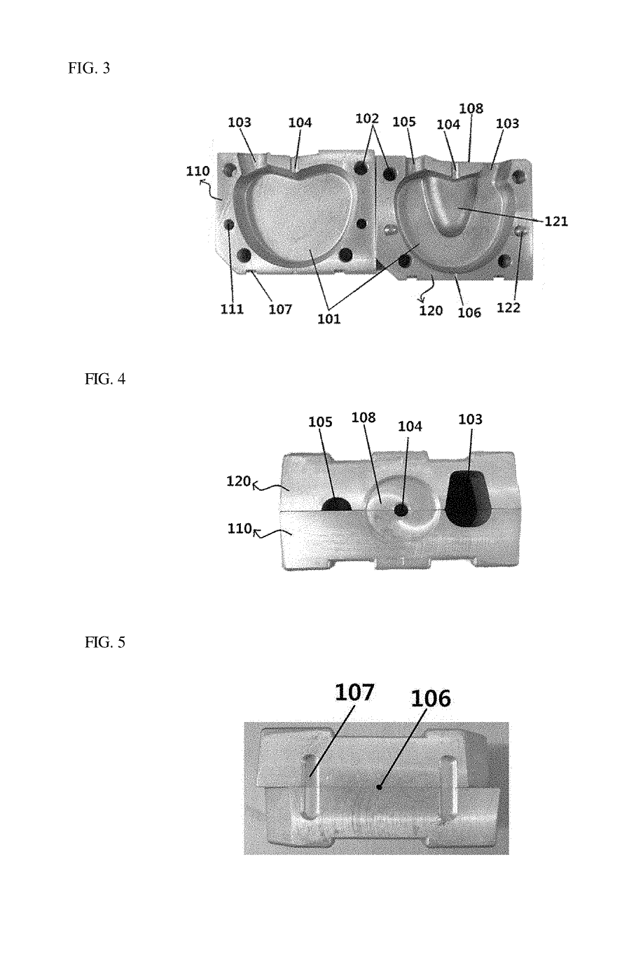

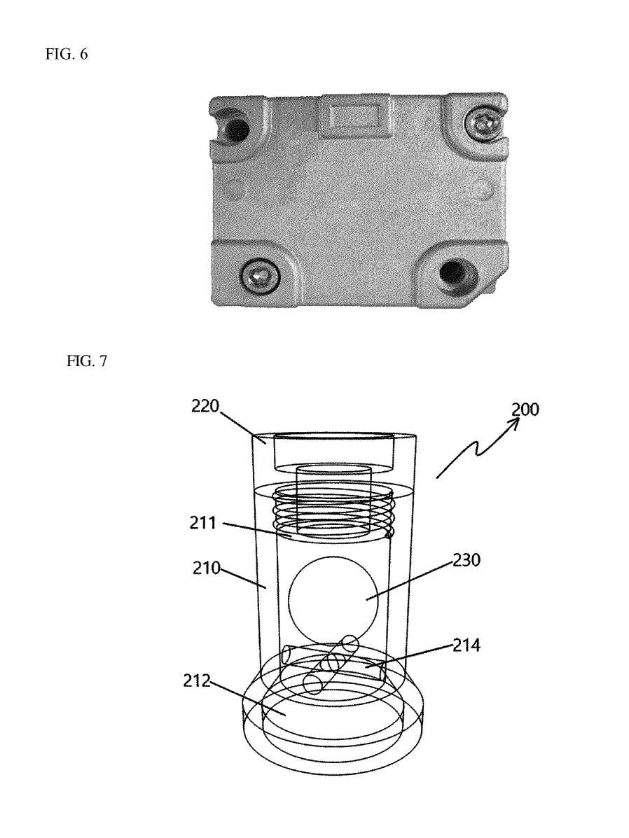

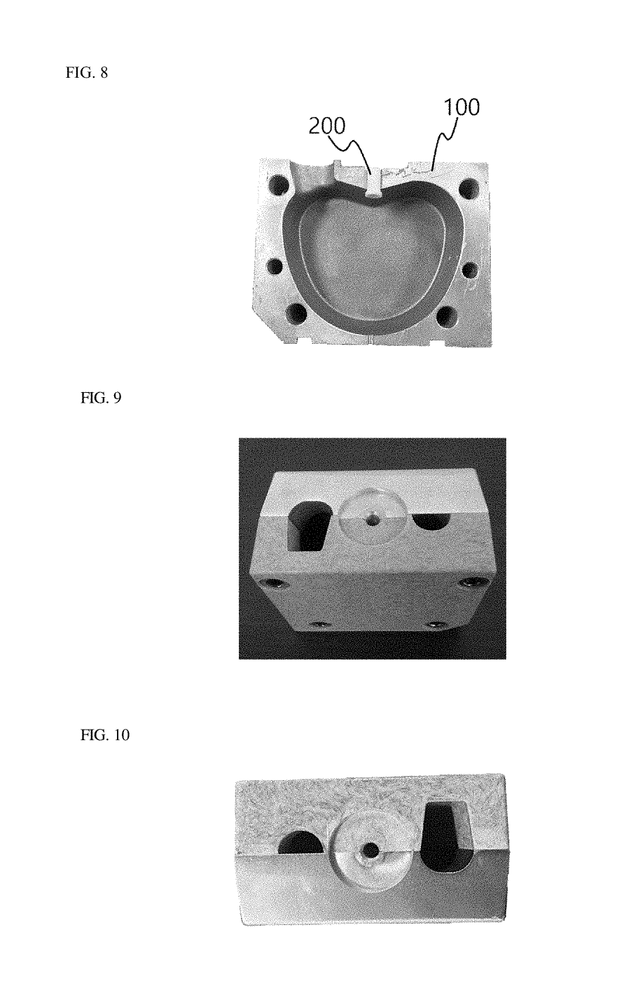

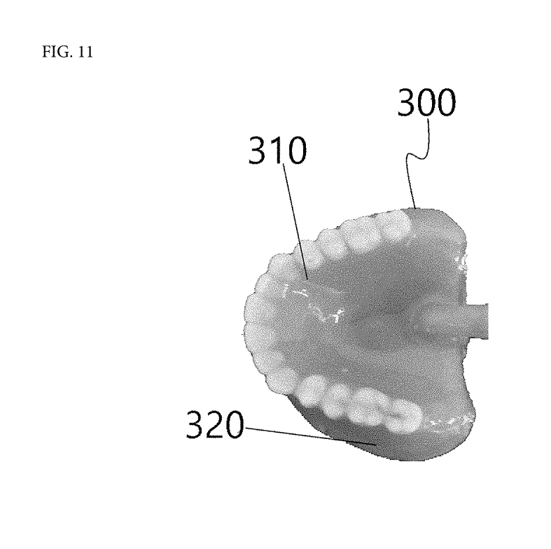

FIG. 1 is a perspective view of an existing denture molding flask; FIG. 2 is an exploded perspective view illustrating an assembling process of the existing denture molding flask; FIG. 3 is a picture illustrating the internal structure of the existing denture molding flask; FIG. 4 is a top view picture of the existing denture molding flask; FIG. 5 is a bottom view picture of the existing denture molding flask; FIG. 6 is a front view picture of the existing denture molding flask; FIG. 7 is a perspective view of a denture molding flask equipped with a check valve, according to the present inventive concept; FIG. 8 is a picture of the denture molding flask equipped with a check valve, according to the present inventive concept; FIG. 9 is a picture of the denture molding flask made of heterogeneous materials, according to the present inventive concept; FIG. 10 is a top view picture of the denture molding flask made of heterogeneous materials, according to the present inventive concept; and FIG. 11 is a picture of a denture prosthesis produced according to the present inventive concept.

According to the present inventive concept, the denture molding flask used to manufacture a denture prosthesis includes the assembled structure composed of the left body 110 and the right body 120, in which: the resin injection hole 104 through which resin is injected is formed at the top portion of the assembled structure of the left body 110 and the right body 120; the investment material injection hole 103 through which plaster serving as an investment material is injected is formed at a position spaced from the resin injection hole 104; a space portion is formed in the left body 110 and the right body 120; a wax denture base is inserted into the space portion and the investment material is injected into the space portion through the investment material injection hole 103; and the wax outlet 106 is provided at the bottom portion of the assembled structure of the left body 110 and the right body 120 such that molten wax is discharged through the wax outlet 106 when the wax denture base and the investment material in the space portion 101 are heated.

In addition, the void that is left by the melting of the wax denture base is refilled with resin injected through the resin injection hole 104.

The left body and the right body are made of different materials. Specifically, the left body is made of a metal material with a higher thermal conductivity and the right body is made of a plastic material with a lower thermal conductivity.

Therefore, when the resin is injected into this flask, the resin in the left body made of a metal material with a higher thermal conductivity is polymerized quickly, but resin in the right body made of a plastic material with a lower thermal conductivity is polymerized slowly.

Therefore, after the resin is injected into the flask, since the resin in the metal-based left body with a higher thermal conductivity is cured quickly but the resin in the plastic-based right body with a lower thermal conductivity is cured slowly. Therefore, although the same resin is used, a denture prosthesis portion in the left body (metal mold) material is first formed through fast thermal polymerization, thereby suffering polymerization shrinkage and deformation, but an artificial teeth portion in the right body (plastic mold) is formed through slow thermal polymerization, thereby experiencing minimal polymerization shrinkage and deformation. The metal material used to form the left body is aluminum. The plastic material used to form the right body is BMC.

A teeth portion of the denture prosthesis is disposed in the plastic-based right body of the flask, a gum portion to which teeth are fixed is disposed in the metal-based left body. Therefore, deformation of a denture prosthesis molded by using the heterogeneous denture molding flask is minimized. Since deformation of the gum portion is minimized, the denture prosthesis has good effects in that it is easy to wear and it provides no foreign body sensation when worn.

The technical feature of the present inventive concept is that the check valve 10 is installed in the resin injection hole 104, thereby preventing deformation of a product attributable to shrinkage of resin or internal pressure drop.

The check valve 200 includes the body 210 having the upper hole 211 and the lower hole 212 respectively formed at the upper portion and the lower portion thereof, the cover 220 installed at the top portion of the body 210 and provided with the central hole, and the ball 230 provided in the body 210 and adapted to move in the vertical direction.

The body and the cover are coupled in a screwed manner. The central hole of the cover 220 has a diameter smaller than that of the ball 230 so that the ball 230 cannot escape the body through the central hole of the cover 220.

In addition, the support pieces 214 are installed in a matrix form in the lower hole of the body 212. Therefore, the ball 230 cannot escape the body through the lower hole because the support pieces 214 block the lower hole.

In addition, the ball 230 has a diameter smaller than the internal diameter of body. Therefore, the upper hole of the body is not blocked by the ball when resin is injected into the body. Thus, the resin can easily flow into the flask through the lower hole of the body without being blocked by the ball.

When dough-state resin is initially injected, the ball is disposed near the lower hole due to an injection pressure. In this case, since the diameter of the lower hole is larger than that of the ball, the resin passes through gaps between the support pieces arranged in a matrix form in the lower hole, and flows into the flask.

After the resin is injected into the flask, the check valve installed in the flask is closed such that the flask is temporarily sealed.

Although the resin injected into the flask slightly shrinks during thermal polymerization reaction, the internal pressure in the flash rises because the resin is injected under a condition of high pressure.

In this case, when resin injection that is performed under a condition of high internal pressure of the flask is finished, the ball in the check valve moves upward, thereby temporarily sealing the flask.

Therefore, the resin in the flask that is temporarily sealed undergoes thermal polymerization has an increased density due to the high internal pressure of the flask.

Therefore, when the flask is sealed, deformation of a product, which is attributable to shrinkage of resin and a decrease in internal pressure, is prevented due to the check valve.

Under a condition of a predetermined pressure or higher, the ball rises up to the upper hole, thereby closing the upper hole, which ensures safety.

The check valve is connected to the resin injection hole 104 of the flask in a welding or press-fitted manner.

Since the check valve is provided at an upper portion of the denture molding flask, the check valve prevents the resin in the flask from coming into contact with outside air during a thermal polymerization process after the resin injection is performed, at the time of manufacturing a denture prosthesis. Therefore, there is a remarkable effect of preventing deformation of a product, thereby producing a denture prosthesis with good quality.

The structure of a denture molding flask used for the present inventive concept will be described below with reference to a denture molding flask disclosed in Korean Patent No. 10-1383037 assigned to the applicant of the present application.

The denture molding flask of the present inventive concept includes a resin injection hole through which resin is injected and that is disposed at a top portion of a flask, an investment material injection hole through which an investment material is injected and that is disposed at the top portion of the flask, a guide hole that is formed at the top portion of the flask and which allows for checking for an amount of an investment material injected into the flask through the investment material injection hole, and a wax outlet that is formed at a bottom portion of the flask and through which wax is discharged.

As illustrated in FIG. 1, the flask has a rectangular box shape and is formed by assembling a left body and a right body. That is, the flask is composed of the left body and the right body. The left body and the right body are assembled with coupling bolts and nuts and can be disassembled.

That is, as illustrated in FIG. 3, each of the left body and the right body is provided with four coupling holes in which the coupling holes of the left body are arranged to correspond to the coupling holes of the right body. Coupling bolts are inserted into the coupling holes, and nuts are engaged with the coupling bolts fitted in the coupling holes. Thus, the left body and the right body are assembled in this way.

In addition, as illustrated in FIG. 3, the right body is provided with a pair of coupling protrusions, and the left body is provided with coupling recesses corresponding to the coupling protrusions. The coupling protrusions and the coupling recesses enable the right body and the left body to be securely coupled to each other.

In addition, as illustrated in FIG. 3, lower left corners of the left and right bodies are chamfered. The chamfered portion makes the left body and the right body be easily assembled with and disassembled from each other.

That is, when the left body and the right body are superimposed, the chamfered corner of the left body meets an unchamfered corner of the right body and an unchamfered corner of the left body meets the chamfered corner of the right body. Therefore, the left body and the right body can be easily assembled and disassembled.

Meanwhile, each of the left body and the right body is provided with a cavity. As illustrated in FIG. 3, a support protrusion is provided in the cavity of the right body, and the cavity of the right body has a horseshoe shape.

The support protrusion is provided to reduce the amount of an investment material injected into the flask. That is, the investment material is not injected to a region which needs not be invested due to the support protrusion. Therefore, the amount of the investment material used can be saved.

That is, a wax denture base is inserted into the horseshoe-shaped cavity of the right body, and the right body and the left body are coupled to each other with the coupling bolts and the nuts.

The upper portion of the flask is provided with the investment material injection hole, the resin injection hole, and the guide hole. The investment material injection hole, the resin injection hole, and the guide hole are formed to communicate with the cavity (space portion) formed in the flask.

That is, when plaster (investment material) is injected through the investment material injection hole, the plaster is injected into the cavity of the flask. At this time, a worker can check the level of the plaster in the flask by visually checking the guide hole formed at the upper portion of the flask.

The lower portion of the flask is provided with the wax outlet such that wax in the flask is discharged outside through the wax outlet.

That is, a denture prosthesis formed in the flask contains solid wax. Therefore, when the flask is heated by a separate heater, the solid wax is melted and thus molten wax (liquid) flows down.

That is, plaster is injected through the investment material injection hole, and then the plaster is hardened. Afterwards, the flask is heated by a heater, so that solid wax in the flask is melted and molten wax is discharged out of the flask through the wax outlet.

That is, since the wax outlet allows liquid flowing down to be discharged out of the flask therethrough, it is not necessary to divide the flask for wax removal.

Next, after the wax is discharged out of the flask, resin is injected into the flask through the resin injection hole provided at the top of the flask. The resin is injected into the cavity of the flask through the resin injection hole.

A process of molding a denture base by using the denture molding flask of the present inventive concept will be described below.

First, a wax denture base is inserted into a horseshoe-shaped cavity formed in a right body of a flask, the right body and a left body of the flask are coupled with coupling bolts and nuts.

Plaster is injected into the cavity of the flask through an investment material injection hole formed at the top surface of the flask. A worker can check how high the investment material in the flask rises by visually checking a guide hole formed in the top surface of the flask.

After the plaster is solidified, the flask is heated by a heater. Thus, solid wax in the flask is melted and molten wax is discharged out of the flask through a wax outlet. After the wax is discharged out of the flask, resin is injected into the flask through a resin injection hole formed at the top surface of the flask.

That is, with the use of the denture molding flask of the present inventive concept, it is not necessary to divide the flask for wax removal and resin injection. Therefore, it is possible to produce a denture with a little difference from natural teeth.

Therefore, the denture molding flask according to the present inventive concept is used to manufacture a denture prosthesis. The denture molding flask is composed of a left body 110 and a right body 120 coupled to each other; a resin injection hole 104 through which resin is injected is formed at a top portion of an assembled structure of the left body 110 and the right body 120; an investment material injection hole 103 through which plaster serving as an investment material is injected is provided at a position spaced from the resin injection hole 104 by a predetermined distance; a space portion is formed in the left body 110 and the right body 120; and a wax outlet 106 through which molten is discharged outside is provided at a bottom portion of the assembled structure of the left body 110 and the right body 120 when a wax denture base and an investment material in the space portion 101 are heated after the wax denture base is inserted into the space portion and the investment material is injected into the space portion through the investment material injection hole 103.

In addition, as to the denture molding flask in which a void left after the wax denture base is melted is filled with resin that is injected through the resin injection hole 104, the resin injection hole 104 is formed by combination of a semicircular opening of the left body 110 and a trapezoidal opening of the right body 120; a tongue-shaped support protrusion 121 is formed in the right body 120 and thus a horseshoe-shaped cavity 101 is formed in the right body 120; and a guide hole 105 having a semicircular shape is formed at the top portion of the assembled structure of the left body 110 and the right body 120 such that the amount of the investment material injected into the cavity 101 through the investment material injection hole 103 can be checked. In addition, as illustrated in FIGS. 3, 5, and 6, any one corner of corners of the left body 110 or the right body 120 is chamfered, and a corresponding corner of the counter part of the left body 110 or the right body 120 is not chamfered. Therefore, the left body 110 and the right body 120 can be easily assembled and disassembled.

Accordingly, a denture prosthesis according to the present inventive concept has remarkable effects in that the denture prosthesis minimally shrinks through thermal polymerization, is easy to wear, and provides no foreign body sensation when worn.

### TECHNICAL PROBLEM

Accordingly, the present inventive concept has been made to address the above problems, and an objective of the present inventive concept is to provide a method of manufacturing a denture prosthesis by using a denture molding flask made of heterogeneous materials in which a left body thereof is made of a metal material having a higher thermal conductivity and a right body thereof is made of a plastic material having a lower thermal conductivity such that, during thermal polymerization of a denture prosthesis, a gum portion of the denture prosthesis is rapidly polymerized and a teeth portion of the denture prosthesis is slowly polymerized, whereby shrinking and deformation of the denture prosthesis is minimized and thus the produced denture prosthesis is easy to wear and gives no foreign body sensation when worn.

### TECHNICAL SOLUTION

In order to accomplish the objective of the present inventive concept, there is provided a method of manufacturing a denture prosthesis by using a denture molding flask made of heterogeneous materials, the denture molding flask being a member used to manufacture a denture prosthesis and composed of a left body 110 and a right body 120 coupled to each other, in which: a resin injection hole 104 through which resin is injected is formed at a top portion of an assembled structure of the left body 10 and the right body 120; an investment material injection hole 103 through which plaster serving as an investment material is injected is provided at a position spaced from the resin injection hole 104 by a predetermined distance; a space portion is formed in the assembled structure of the left body 110 and the right body 120; an investment material is injected into the space portion through the investment material injection hole 103 after a wax denture base is inserted into the space portion; an wax outlet 106 through which molten wax is discharged is formed at a bottom portion of the assembled structure of the left body 110 and the right body 120 such that the molten wax is discharged outside while the denture base and the investment material in the space portion 101 are heated; a void left by the melting of the denture base is refilled with resin injected through the resin injection hole 104 to produce the denture prosthesis,

wherein the left body 110 and the right body 120 are made of respectively different materials, thereby minimizing polymerization shrinkage and deformation of the dental prosthesis formed in the left body 110 and the right body 120.

### ADVANTAGEOUS EFFECTS

Therefore, according to the present inventive concept, the left body is made of a metal material having a higher thermal conductivity and the right body is made of a plastic material having a lower thermal conductivity. A denture prosthesis prepared by using the denture molding flask made of heterogeneous materials minimally shrinks or deforms during polymerization, is easy to wear, and gives no foreign body sensation when worn.

In addition, since the flask is equipped with a check valve installed at a top portion thereof, it is possible to prevent deformation of a product attributable to shrinkage of resin and an internal pressure drop during a resin insertion process and a thermal polymerization process when a denture prosthesis is manufactured. Therefore, there is a remarkable effect of producing a denture prosthesis with good quality.

1.-6. (canceled)

7. A denture molding flask comprising:
a left body and a right body coupled to each other;
a resin injection hole through which resin is injected, the resin injection hole being formed at a top portion of an assembled structure of the left body and the right body;
an investment material injection hole through which an investment material is injected, the investment material injection hole being provided at a position spaced apart from the resin injection hole by a predetermined distance;
a space formed between the left body and the right body; and
a wax outlet through which molten wax is discharged to outside, the wax outlet being formed at a bottom portion of the assembled structure of the left body and the right body,
wherein the left body and the right body are made of different materials.

8. The denture molding flask of claim 7, wherein the left body is made of a metal material with a higher thermal conductivity and the right body is made of a plastic material with a lower thermal conductivity than the metal material.

9. The denture molding flask of claim 8, wherein the metal material is aluminum and the plastic material is BMC (Bulk Molding Compound).

10. The denture molding flask of claim 7, further comprising a check valve coupled to the resin injection hole.

11. The denture molding flask of claim 10, wherein the check valve comprising:
a body having an upper hole and a lower hole respectively formed at a top portion and a bottom portion of the body, the body being fixed to the resin injection hole,
a cover disposed at the top portion of the body and provided with a central hole, and
a ball provided in the body and adapted to move in a vertical direction.

12. The denture molding flask of claim 11, further comprising support pieces disposed below the lower hole, the supporting pieces having a matrix configuration such that the support pieces prevent the ball from escaping the check valve through the lower hole.

13. A denture molding flask comprising:
a left body and a right body coupled to each other;
a resin injection hole through which resin is injected, the resin injection hole being formed at a top portion of an assembled structure of the left body and the right body;
an investment material injection hole through which an investment material is injected, the investment material injection hole being provided at a position spaced apart from the resin injection hole by a predetermined distance;
a space formed between the left body and the right body;
a wax outlet through which molten wax is discharged outside, the wax outlet being formed at a bottom portion of the assembled structure of the left body and the right body; and
a check valve coupled to the resin injection hole.

14. The denture molding flask of claim 13, wherein the check valve comprising:
a body having an upper hole and a lower hole respectively formed at a top portion and a bottom portion of the body, the body being fixed to the resin injection hole,
a cover disposed at the top portion of the body and provided with a central hole, and
a ball provided in the body and adapted to move in a vertical direction.

15. The denture molding flask of claim 14, further comprising support pieces disposed below the lower hole, the supporting pieces having a matrix configuration such that the support pieces prevent the ball from escaping the check valve through the lower hole.
